(19) United States
(12) Patent Application Publication
(10) Pub. No.: US 2012/0062485 A1
(43) Pub. Date: Mar. 15, 2012

(54) ON-CELL TSP ACTIVE MATRIX ORGANIC LIGHT EMITTING DIODE DISPLAY

(75) Inventor: Soo Hyung KIM, Hwaseong-si (KR)

(73) Assignee: SAMSUNG ELECTRONICS CO. LTD., Suwon-si (KR)

(21) Appl. No.: 13/110,289

(22) Filed: May 18, 2011

(30) Foreign Application Priority Data
Sep. 15, 2010 (KR) 10-2010-0090255

(51) Int. Cl. G06F 3/041; G09G 3/30

(52) U.S. Cl. 345/173; 345/76

(57) ABSTRACT

An On-Cell Touch Screen Panel (TSP) active matrix Organic Light Emitting Diode (OLED) display is provided. The On-Cell TSP active matrix OLED display includes a conductive layer formed at a rear surface of the window, and a ground connection portion having one end connected to the conductive layer so as to ground the conductive layer. Therefore, upon performing an Electrostatic Discharge (ESD) test, a TSP Indium Tin Oxide (ITO) pattern can be prevented from being damaged.

### PRIORITY

This application claims the benefit under 35 U.S.C. §119(a) of a Korean patent application filed on Sep. 15, 2010 in the Korean Intellectual Property Office and assigned Serial No. 10-2010-0090255, the entire disclosure of which is hereby incorporated by reference.

### BACKGROUND OF THE INVENTION

1. Field of the Invention

The present invention relates to an On-Cell Touch Screen Panel (TSP) active matrix Organic Light Emitting Diode (OLED) display. More particularly, the present invention relates to an On-Cell TSP active matrix OLED display for preventing a TSP Indium Tin Oxide (ITO) pattern from being damaged upon performing an Electrostatic Discharge (ESD) test.

2. Description of the Related Art

Touch screen technologies using an active matrix OLED having an excellent optical characteristic are presently being applied to a mobile terminal. The touch screen technologies include forming a touch screen pattern at a rear surface of a window of the mobile terminal and an On-Cell TSP in which a touch screen pattern is formed in an upper surface of an active matrix OLED. In the former, because an air gap is formed between a window having a touch screen pattern at the rear surface and an active matrix OLED, reflection occurs by a refractive index difference due to the air gap. Therefore, when strong external light occurs, it is difficult for a user to view a vivid screen. As a result, an On-Cell TSP active matrix OLED display is generally used.

FIG. 1 is an exploded perspective view illustrating a conventional On-Cell TSP active matrix OLED display.

Referring to FIG. 1, an On-Cell TSP active matrix OLED display 100 includes an active matrix OLED 110, a polarizing plate 120 disposed at an upper part of the active matrix OLED 110, and a window 130 disposed at an upper part of the polarizing plate 120.

The active matrix OLED 110 has a Low Temperature Polycrystalline Silicon (LTPS) glass 111 and an encap glass 112. A TSP ITO pattern (not shown) is formed at an upper surface of the encap glass 112. A mobile terminal including the On-Cell TSP active matrix OLED display 100 performs an ESD test to determine whether the mobile terminal can withstand a normal level of static electricity that may occur in actual environment, as in a normal mobile terminal. The ESD test is performed while a window of the mobile terminal faces upward or downward.

FIG. 2 is a schematic cross-sectional view illustrating an Electrostatic Discharge (ESD) test of a mobile terminal having a conventional On-Cell TSP active matrix OLED display.

Referring to FIG. 2, the ESD test performed while the window 130 of a mobile terminal 101 faces downward is described.

First, the mobile terminal 101 is put on a ground plate 300 of an ESD test device so that the window 130 contacts with an insulation layer 301 of the ground plate 300. High voltage is applied to the mobile terminal 101. As shown in FIG. 2, because the polarizing plate 120, a resin 121, and the window 130 positioned between a TSP ITO pattern and the ground plate 300 are formed with nonmetal, when an electric charge is suddenly applied to the TSP ITO pattern 113, the TSP ITO pattern 113 may be damaged.

### SUMMARY OF THE INVENTION

An aspect of the present invention is to addresses at least the above-mentioned problems and/or disadvantages and to provide at least the advantages described below. Accordingly, an aspect of the present invention is to provide an On-Cell Touch Screen Panel (TSP) active matrix Organic Light Emitting Diode (OLED) display for preventing a TSP Indium Tin Oxide (ITO) pattern from being damaged when an Electrostatic Discharge (ESD) test is performed in a mobile terminal having the On-Cell TSP active matrix OLED display.

In accordance with an aspect of the present invention, an On-Cell TSP active matrix OLED display having a window is provided. The display includes a conductive layer formed at a rear surface of the window, and a ground connection portion having one end connected to the conductive layer so as to ground the conductive layer.

In accordance with another aspect of the present invention, an On-Cell TSP active matrix OLED display having a window is provided. The display includes, a conductive layer formed at a rear surface of the window, and a bracket directly connected to the conductive layer so as to ground the conductive layer.

In accordance with another aspect of the present invention, an apparatus is provided. The apparatus includes a TSP active matrix OLED display including an active matrix OLED, a window arranged above the OLED and having a black mark area surrounding the active matrix OLED, a conductive layer formed at a rear surface of the window in the black mark area, and a ground connection portion having one end connected to the conductive layer so as to ground the conductive layer.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is an exploded perspective view illustrating a conventional On-Cell Touch Screen Panel (TSP) active matrix Organic Light Emitting Diode (OLED) display;

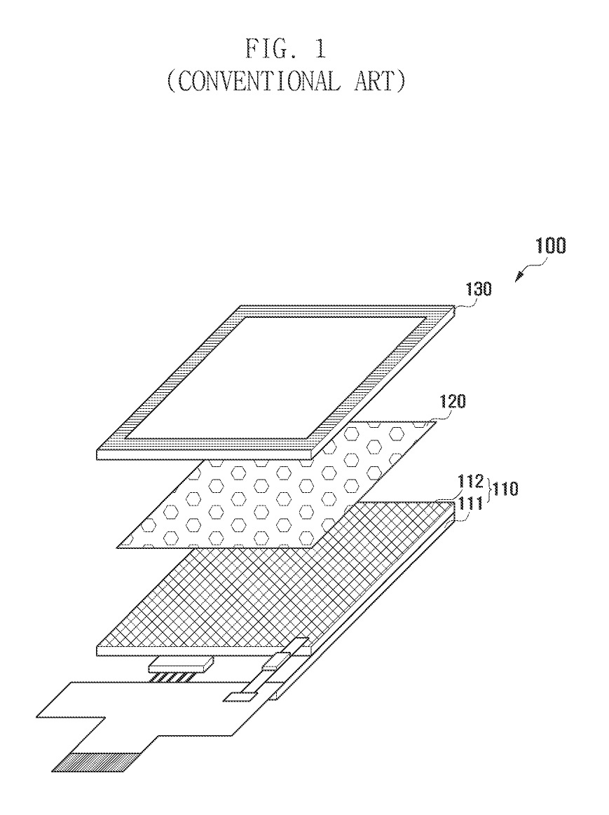

FIG. 2 is a schematic cross-sectional view illustrating an Electrostatic Discharge (ESD) test of a mobile terminal having a conventional On-Cell TSP active matrix OLED display;

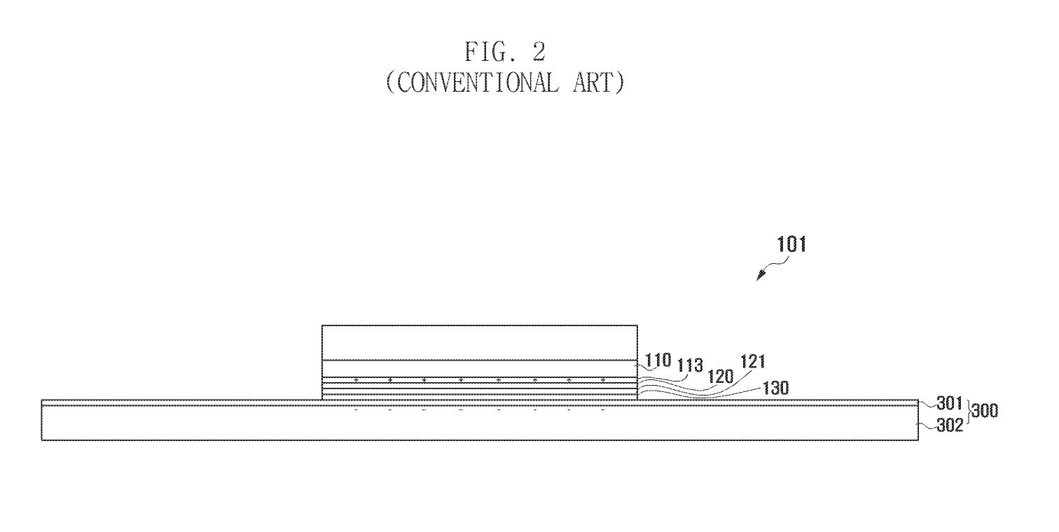

FIG. 3 is a plan view illustrating a mobile terminal having an On-Cell TSP active matrix OLED display according to an exemplary embodiment of the present invention;

FIG. 4 is a cross-sectional view illustrating an On-Cell TSP active matrix OLED display taken along a dotted line A-A′ of FIG. 3 according to an exemplary embodiment of the present invention;

FIG. 5 is an exploded perspective view illustrating an On-Cell TSP active matrix OLED display according to an exemplary embodiment of the present invention;

FIG. 6 is a rear view illustrating a window of an On-Cell TSP active matrix OLED display according to an exemplary embodiment of the present invention; and

FIG. 7 is a schematic cross-sectional view illustrating an ESD test of a mobile terminal having an On-Cell TSP active matrix OLED display according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

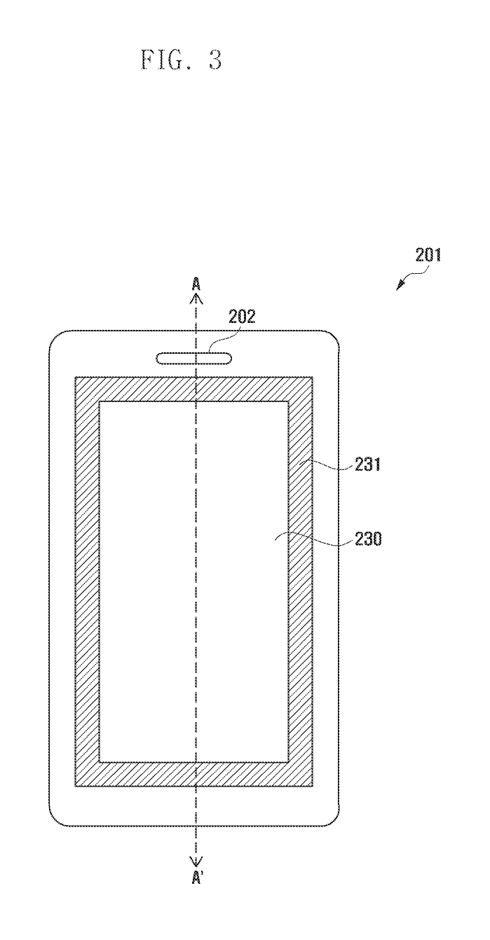

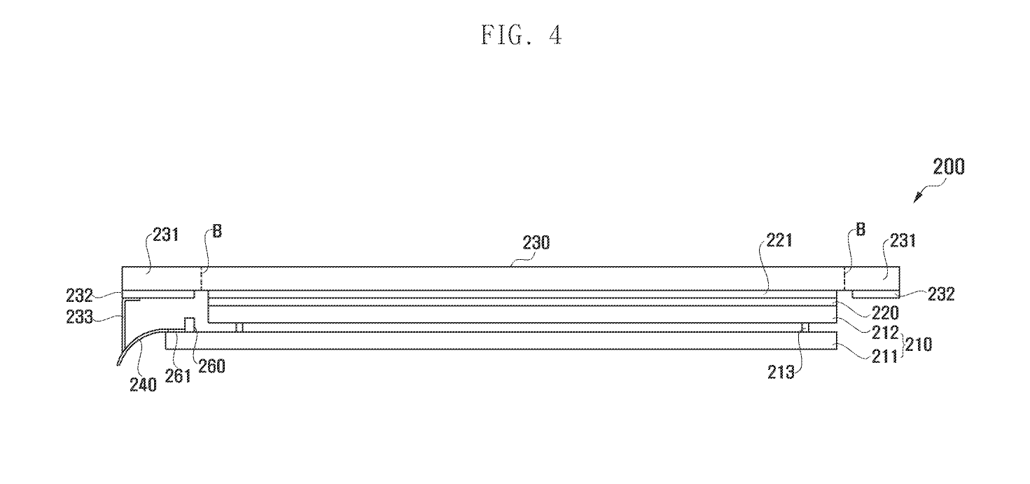

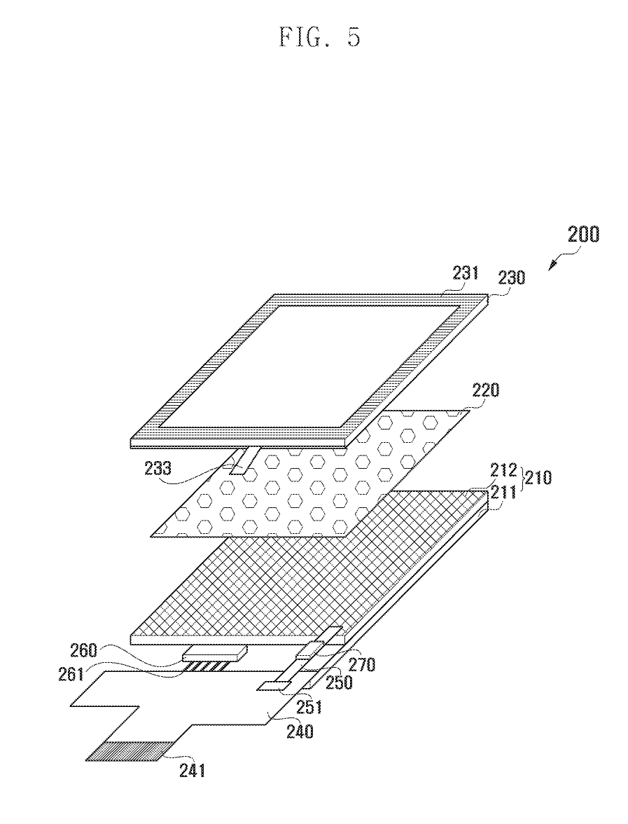

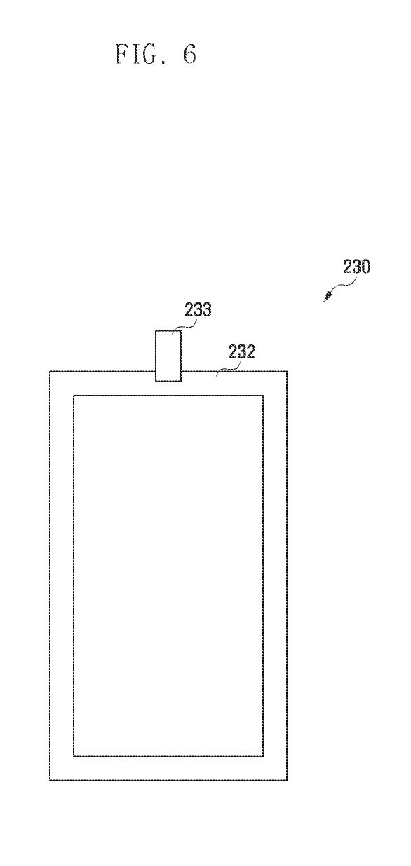

FIG. 3 is a plan view illustrating a mobile terminal having an On-Cell Touch Screen Panel (TSP) active matrix Organic Light Emitting Diode (OLED) display according to an exemplary embodiment of the present invention, and FIG. 4 is a cross-sectional view illustrating an On-Cell TSP active matrix OLED display in the mobile terminal taken along a dotted line A-A′ of FIG. 3. FIG. 5 is an exploded perspective view illustrating an On-Cell TSP active matrix OLED display according to an exemplary embodiment of the present invention, and FIG. 6 is a rear view illustrating a window of an On-Cell TSP active matrix OLED display according to an exemplary embodiment of the present invention. For reference, the dotted line A-A′ of FIG. 3 is disposed in a vertical direction along a speaker hole 202 of a mobile terminal 201 and the center of a window 230.

Referring to FIGS. 3 to 6, an On-Cell TSP active matrix OLED display 200 according to an exemplary embodiment of the present invention includes an active matrix OLED 210 and a window 230.

The active matrix OLED 210 includes a Low Temperature Polycrystalline Silicon (LTPS) glass 211 formed with a light emitting organic material to perform self light emission and an encap glass 212 for sealing an upper part of the LTPS glass 211. Space between a lower surface of the encap glass 212 and an upper surface of the LTPS glass 211 is sealed by a cell seal 213 formed with metal glass. The sealed space is filled with nitrogen gas. A polarizing plate 220 for preventing external light from being reflected from the active matrix OLED is formed at an upper part of the encap glass 212. A TSP Indium Tin Oxide (ITO) pattern (not shown) is formed between an upper surface of the encap glass 212 and a lower surface of the polarizing plate 220.

A Display Driver IC (DDI) 260 for driving the active matrix OLED 210 is positioned at an upper surface of one side of the LTPS glass 211. The DDI 260 is connected to one end of an active matrix OLED Flexible Printed Circuit Board (FPCB) 240 by a connection line 261. The active matrix OLED FPCB 240 is connected to a main board (not shown) by a connector 241 formed at the other end thereof The active matrix OLED FPCB 240 is connected by a connector 251 to one end of a Touch Screen Driver IC (TDI) FPCB 250 in which a TDI 270 is mounted at an upper surface thereof The other end of the TDI FPCB 250 is connected to a metal trace (not shown) connected to a TSP ITO pattern.

The window 230 is stacked at an upper part of the polarizing plate 220. A resin 221 is formed between a rear surface of the window 230 and an upper surface of the polarizing plate 220. The window 230 has a black mark area 231 (the outer area of a dotted line B in FIG. 4). The black mark area 231 is a black area in which a screen is not displayed, as shown in FIG. 3. A grounded conductive layer 232 is formed in the black mark area 231 of a rear surface of the window 230. As shown in FIGS. 4 and 5, the black mark area 231 is grounded by a ground connection portion 233 having one end connected to the conductive layer 232 and the other end connected to a ground line (not shown) of the active matrix OLED FPCB 240. The ground connection portion 233 is formed with a FPCB or a conductive material. One end of the ground connection portion 233, a portion connected to the conductive layer 232, may be positioned at an upper part of the active matrix OLED FPCB 240. The other end of the ground connection portion 233 may be connected to a bracket (not shown), or the conductive layer 232 may be directly connected to the bracket, and thus the other end of the ground connection portion 233 or the conductive layer 232 may be electrically connected to a ground portion (not shown) of the mobile terminal 201.

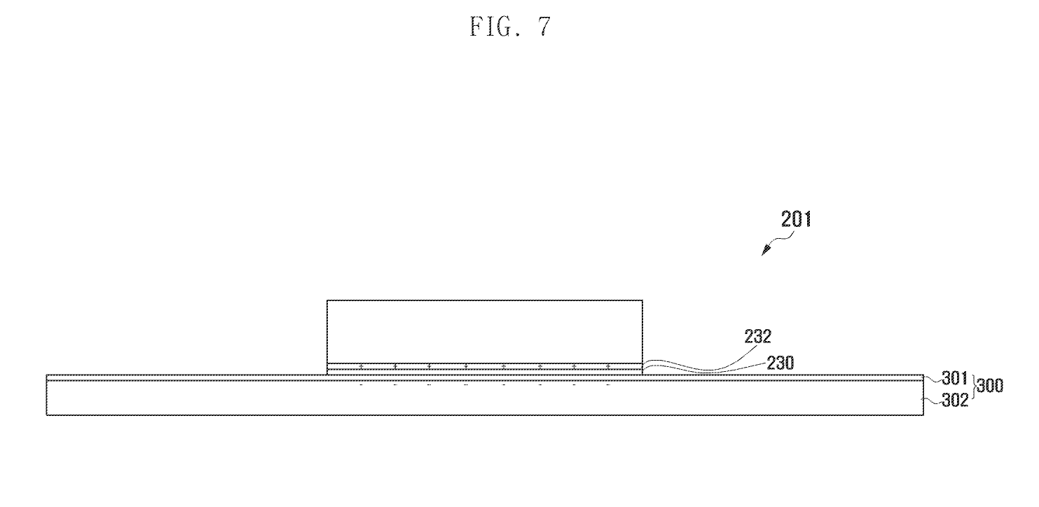

FIG. 7 is a schematic cross-sectional view illustrating an ESD test of a mobile terminal having an On-Cell TSP active matrix OLED display according to an exemplary embodiment of the present invention.

Referring to FIG. 7, an ESD test of the mobile terminal 201 having the On-Cell TSP active matrix OLED display 200 according to an exemplary embodiment of the present invention is performed as follows.

The mobile terminal 201 is put on a ground plate 300 of an ESD test device having a substrate 302 and an insulation layer 301 so that the window 230 contacts the insulation layer 301 of the ground plate 300. High voltage is applied to the mobile terminal 201. As shown in FIG. 7, electric charges are concentrically electrified to a conductive layer 232 formed and grounded at a black mark area in a rear surface of the window 230. Accordingly, because an electric charge is not applied to a TSP ITO pattern, damage to the TSP ITO pattern is prevented.

As described above, according to exemplary embodiments of the present invention, as a conductive layer formed at a rear surface of a window is grounded by a ground connection portion or a bracket, when an ESD test is performed, damage to a TSP ITO pattern can be prevented. Accordingly, in a mobile terminal having an On-Cell TSP active matrix OLED display, failure can be prevented from occurring, a developing period can be shortened, and a developing cost can be reduced.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An On-Cell Touch Screen Panel (TSP) active matrix Organic Light Emitting Diode (OLED) display having a window, comprising:
a conductive layer formed at a rear surface of the window; and
a ground connection portion having one end connected to the conductive layer so as to ground the conductive layer.

2. The On-Cell TSP active matrix OLED display of claim 1, wherein the conductive layer is formed in a black mark area of the window.

3. The On-Cell TSP active matrix OLED display of claim 1, wherein the other end of the ground connection portion is connected to a ground connection line of an active matrix OLED Flexible Printed Circuit Board (FPCB).

4. The On-Cell TSP active matrix OLED display of claim 1, wherein the other end of the ground connection portion is electrically connected to a ground portion through a bracket.

5. The On-Cell TSP active matrix OLED display of claim 1, wherein the ground connection portion comprises a Flexible Printed Circuit Board (FPCB).

6. The On-Cell TSP active matrix OLED display of claim 1, wherein at one end of the ground connection portion, the portion of the ground connection portion connected to the conductive layer is positioned at an upper part of an active matrix OLED Flexible Printed Circuit Board (FPCB).

7. An On-Cell Touch Screen Panel (TSP) active matrix Organic Light Emitting Diode (OLED) display having a window, comprising:
a conductive layer formed at a rear surface of the window; and
a bracket directly connected to the conductive layer so as to ground the conductive layer.

8. The On-Cell TSP active matrix OLED display of claim 7, wherein the conductive layer is formed in a black mark area of the window.

9. An apparatus comprising:
a Touch Screen Panel (TSP) active matrix Organic Light Emitting Diode (OLED) display including:
an active matrix OLED;
a window arranged above the OLED and having a black mark area surrounding the active matrix OLED;
a conductive layer formed at a rear surface of the window in the black mark area; and
a ground connection portion having one end connected to the conductive layer so as to ground the conductive layer.

10. The apparatus of claim 9, wherein the display further comprises a bracket.

11. The apparatus of claim 10, wherein the conductive layer is directly connected to the bracket.

12. The apparatus of claim 9, wherein the end of the ground connection portion not connected to the conductive layer is connected to a ground of the apparatus.

13. The apparatus of claim 10, wherein the end of the ground connection portion not connected to the conductive layer is connected to the bracket.

14. The apparatus of claim 9, wherein the display further comprises:
a driver for driving the active matrix OLED; and
an OLED Flexible Printed Circuit Board (FPCB) having one end attached to the driver.

15. The apparatus of claim 14, wherein the end of the ground connection portion connected to the conductive layer has a portion connected to the OLED FPCB.

16. The apparatus of claim 9, wherein the apparatus comprises a mobile terminal
